(19) United States
(12) Patent Application Publication
(10) Pub. No.: US 2016/0177985 A1
(43) Pub. Date: Jun. 23, 2016

(54) STRUCTURE SECURING DEVICE

(71) Applicant: LISI AEROSPACE, Paris Cedex 12 (FR)

(72) Inventors: Guy Pailhories, Villefranche de Rouergue (FR); Yoann Douard, Saint Remy (FR)

(73) Assignee: LISI AEROSPACE, Paris Cedex 12 (FR)

(21) Appl. No.: 14/910,667

(22) PCT Filed: Jul. 31, 2014
(86) PCT No.: PCT/EP2014/066471

§ 371 Date: Feb. 5, 2016

(30) Foreign Application Priority Data
Aug. 5, 2013 (FR) 1357791

(51) Int. Cl. F16B 5/02; F16B 39/34

(52) U.S. Cl. CPC F16B 5/0258; F16B 39/34

(57) ABSTRACT

The invention relates to a securing device (10) for a structure (11) having an open-ended cylindrical bore (13a), the securing device comprising:
an insert (15) comprising a tapped tubular body (16) and a head (18), the extremity (20) of the body opposite the head comprising an annular cavity holding a ring (21) made of a plastic material;
a pin (22) comprising a cylindrical tapped rod (16) assembled with the tapping of the insert and a head (23), the extremity (30) of the cylindrical threaded rod being tapered;

the device being characterized in that the threaded rod is introduced into the insert on the ring side such that, in the assembled state, the head of the insert and the head of the pin form the terminal ends of the securing device (10).

The invention also relates to an assembly for the installation of such a device, and also to an installation method.

The present invention relates to a pin/insert type of device for securing structure elements, utilizing a tapped insert fixed in a structure.

The invention relates notably to the aeronautics field and is intended for securing equipment to engine covers or structural airplane panels made of composite material.

Devices for securing equipment on covers or panels made of aluminum are already known. In particular, rivet inserts for thin sheets, key inserts for very large parts, and floating inserts as described, for example, in document EP0643231, can be cited.

Composite materials bring new resilience and assembly constraints, which require a technical evolution of the securing device. In addition, because of the destination of the device, elements are only allowed to project by a small amount on either side of the structure.

In addition, it is desirable to be able to screw or unscrew the pins several times, for example for installing/removing equipment during maintenance without having to change the inserts installed in the structure. Using titanium alloy pins allows the weight of the fastener to be reduced, but generates a greater risk of locking and of damage to the locking devices currently implemented, through deformation of the insert's material, which compromises the number of screwing/unscrewing operations possible.

The present invention allows these problems to be resolved. More specifically, the invention relates to a securing device for a structure having an open-ended cylindrical bore, the securing device comprising: an insert comprising a cylindrical tubular body provided with internal tapping, a head with radial dimensions greater than the dimensions of the body, the extremity of the body opposite the head comprising an annular cavity holding a ring made of a plastic material;
a pin comprising a cylindrical threaded rod joined to the tapping of the insert, a head with radial dimensions greater than the dimensions of said rod, the extremity of the cylindrical threaded rod being tapered; where the device's threaded rod is introduced into the insert on the ring side such that, in the assembled state, the head of the insert and the head of the pin form the terminal ends of the securing device.

The ring made of plastic material, preferably of polyimide, provides a locking function so as to prevent the unwanted loosening of the pin under the effect of vibrations, for example. In addition, this plastic ring considerably reduces the risks of locking, by the use of titanium alloy pins, and makes it possible to considerably increase the number of screwing/unscrewing operations possible.

Preferably, an outer surface of the tubular body of the insert comprises longitudinal splines, in contact with the adhesive material. The longitudinal splines allow a better distribution of an adhesive, and therefore greater solidity of the structure/insert assembly after polymerization.

Preferably, the tapered threaded portion of the pin is contained within the body of the insert. Thus, there is no projection of the pin at the location of at least one of the surfaces of the structure.

Preferably, the ring, when new, has an internal diameter less than the maximum diameter of the threaded rod of the pin. “Maximum diameter of the threaded rod” refers to a diameter tangent to the summits of the threads.

The invention also relates to a structure having an open-ended cylindrical bore, said structure comprising a securing device as described above, the structure being such that the body of the insert is inserted into the bore, the outer surface of the tubular body being connected to an inner surface of the bore using an adhesive.

Preferably the head of the insert is in contact with a surface of the structure.

The invention also relates to an assembly for the installation of a securing device as described above, said assembly comprising an insert as described above, as well as a device for retaining the insert. The retaining device is formed of a material deformable by compression and comprises: an introduction rod, having a diameter smaller than an inner diameter of the insert; a retaining portion adjacent to the introduction rod having a diameter greater than the inner diameter of the insert and able to be introduced into the insert by compression; a flexible skirt adjacent to the retaining portion, a flare of the skirt being oriented towards said retaining portion; a grasping end, adjacent to the flexible skirt.

The purpose of the retaining device is to insert and retain the insert in the bore before the adhesive sets.

The invention also relates to a method for installing a securing device as described above, said method utilizing an assembly as described above and comprising the following steps:
inserting the introduction rod into the insert, from the side opposite the head;
immobilizing the insert around the retaining portion by compression of said portion;
distributing a polymerizable adhesive fluid over the outer surface of the body of the insert;
inserting the retaining device into the bore of the structure from the side of the first surface, by the grasping end, until the flexible skirt emerges from an opposite side and the head of the insert is placed in contact with the first surface;
pulling on the introduction rod so as to press the skirt against the structure;
polymerizing the adhesive;
extracting the retaining device by pulling on the grasping end.

Preferably, the ring made of plastic material is tapped by screwing a threaded rod into the insert, said threaded rod then being introduced from the side of the head of the insert, before or after the insert is installed in the structure. The tapping is thus preformed on the ring, in the continuation of the tapping of the insert.

The invention will be better understood when reading the following description and examining the accompanying figures. These are provided for information purposes only and are not exhaustive concerning the invention. The figures illustrate the following:

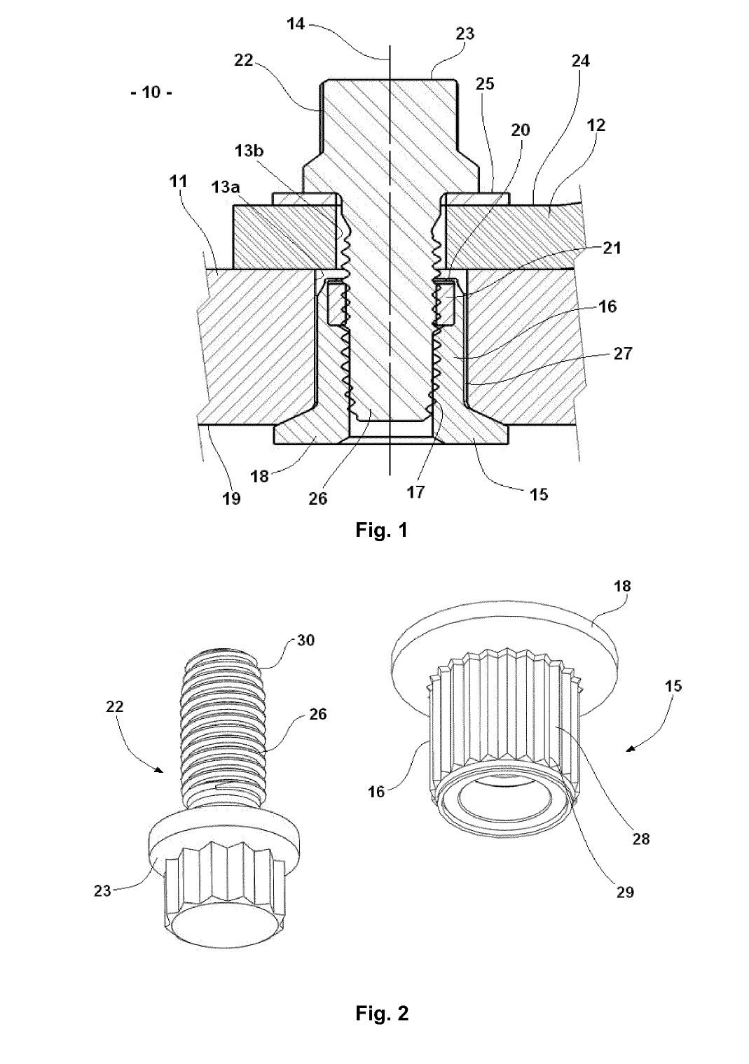

FIG. 1: A cross-section view of a device according to one embodiment of the invention;

FIG. 2: a perspective view of elements depicted in FIG. 1, in the separated state;

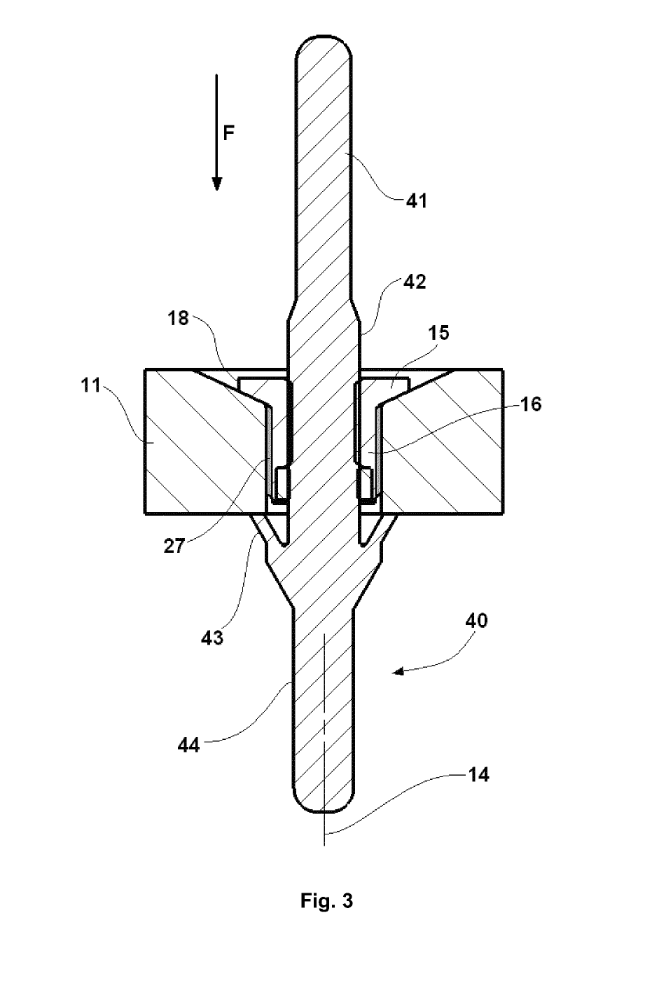

FIG. 3: a cross-section view of an assembly for the installation of the device of FIG. 1.

FIG. 1 illustrates a cross-section view of a securing device 10 according to one embodiment of the invention.

The role of the device 10 is to assemble a piece of equipment or a bracket 12 onto a panel 11. Said panel 11 is provided with a through bore 13a, positioned along an axis 14. The piece of equipment 12 is, for example, provided with a fastener plate having a hole 13b.

The panel 11 and the piece of equipment 12 are in contact with each other, the bore 13a and the hole 13b being positioned coaxially. In this example, the bore 13a and the hole 13b do not have the same diameter.

The device 10 comprises a metallic insert 15, said insert comprising a tubular body 16 provided with internal tapping 17. The tubular body 16 extends along the axis 14. The dimensions of the bore 13a of the panel 11 are suitable for installing the tubular body 16 in said bore.

In addition, the insert 15 is secured to the bore 13a of the panel 11 by an adhesive material 27. The insert is thus blocked in rotation inside the bore.

The body 16 is connected to a head 18 with a diameter greater than the diameter of the body 16, in contact with a first surface 19 of the panel 11. In the example in FIG. 1, the head 18 is countersunk and the bore 13a itself comprises countersinking in which the head 18 is set, said head being substantially coplanar with surface 19. According to another embodiment of the invention, the head 18 protrudes relative to the surface 19.

One axial extremity 20 of the body 16, opposite to the head 18, comprises an untapped inner annular cavity into which a ring 21 made of plastic material is installed. The ring 21 is secured to the body 16, for example by crimping the axial extremity 20, so as to be blocked in rotation along the axis 14. The material of the ring 21 is, for example, polyimide or polyamide. VESPEL® material supplied by DuPont is suitable for producing the ring 21.

The device 10 also comprises a pin 22 positioned along the axis 14. Said pin comprises a protruding head 23, in contact with a washer 25, itself in contact with a second surface 24 of the piece of equipment 12. According to one variant, the washer is not used and the head 23 is in direct contact with the surface 24.

The head 23 is connected to a cylindrical threaded rod 26. The cylindrical threaded rod 26 is assembled with the tapping 17 of the insert. In a variant, the pin can comprise a cylindrical smooth shank to adapt to the thickness of the element 12.

An inner diameter of the ring 21 is less than the maximum diameter of the cylindrical threaded rod 26. “Maximum diameter” refers to a diameter tangent to the summits of the threads. Therefore, said threads are able to hollow out the material of the ring 21 during the first screwing of the pin into the insert.

When a pin 22 is inserted into a new insert 15, the ring 21 is therefore tapped by the action of the threading of the rod 26.

Alternatively, this step can be carried out before the insert 15 is installed in the panel 11, during its production in factory, using a threaded rod having the same thread as that of the pin 22.

Preferably, for this tapping step, a threaded rod is introduced from the side of the head 18 of the insert, i.e. from the side opposite the installation as represented in FIG. 1. Therefore, when the threaded rod 26 reaches the new ring 21, it already fits into the tapping 17 of the insert. The tapping formed on the material of the ring 21 is therefore continuous with the tapping 17 of the insert 15.

FIG. 2 shows a perspective view of the insert 15 and the pin 22 in the unassembled state.

An outer surface 28 of the body 16 of the insert comprises longitudinal splines 29. These splines allow better distribution of the adhesive material 27 and better positioning of the insert 15 in the bore 13.

One extremity of the pin 22, opposite the head 23, is formed by a tapered threaded portion 30, adjacent to the cylindrical threaded rod 26. As the portion 30 gets farther from the head 23, the diameter gets smaller.

This tapered portion 30 serves as guide for the pin 22 when it is introduced into the insert 15. If the ring 21 has been tapped beforehand, the gradual increase in the diameter of the threading facilitates the engagement of said threading with the tapping of the ring 21. If the ring 21 is new, the gradual increase in the diameter of the threading facilitates the tapping of the ring, and progressively increases the screwing torque of the pin 22 in the insert 15.

When the pin 22 is installed in the insert 15, as in FIG. 1, the presence of the plastic ring 21 ensures locking of the pin and thus limits the risks of the pin 22 loosening.

The head 23 of the pin and the head 18 of the insert are positioned opposite each other so as to form the terminal ends of the securing device 10 bearing against two opposite surfaces of the structure. Thus, the dimensions of the securing device outside the panel 11 are minimal. In addition, the head 18 of the insert opposes the tensile force exercised by the pin 22, generated by the weight and vibrations of the piece of equipment 12. The locking ring 21 positioned at the axial extremity 20 of the insert locks the first threads of the pin 22 located as close as possible to the head 23, which limits as far as possible any movement of the pin after assembly.

FIG. 3 shows a cross-section view of the insert 15 and the panel 11 during a method for installing the device 10.

Before assembling the pin 22 with the insert 15, it is necessary to fit said insert 15 into the bore 13a of the panel 11, and to secure said insert 15 to the panel 11 using the adhesive material 27.

For this purpose, a retaining device 40 is used. The device 40 is formed in a deformable material, such as silicone.

The retaining device 40 extends along the axis 14 and comprises an introduction rod 41, having a diameter smaller than an inner diameter of the insert. This rod 41 is adjacent to a retaining portion 42, having a diameter greater than the inner diameter of the insert. In FIG. 3, the portion 42 is introduced into the insert and deformed by compression.

The device 40 also comprises a flexible skirt 43, adjacent to the retaining portion. A flare of the skirt is oriented towards said retaining portion. Lastly, the device 40 comprises a grasping end 44, adjacent to the flexible skirt. A diameter of the end 44 is less than the diameter of the bore 13a.

A method for installing the device 10 can occur as follows: Firstly, the retaining device 40 is assembled with the insert 15, by inserting the introduction rod 41 into said insert, from the side opposite the head 18. By pulling on the rod 41, the insert 15 is then wedged in the retaining portion 42, whose deformable material is compressed by the body 16 of the insert.

An adhesive 27 is then distributed over the outer surface 28 of the body of the insert, in particular over the longitudinal splines 29. The adhesive is preferably a curable viscous fluid, in particular formed of two components that are combined just before application. It is also possible to distribute the adhesive in the bore 13a of the structure, or to distribute the adhesive both over the surface 28 of the insert, and over the surface of the bore 13a.

The device 40 is then inserted into the bore 13 of the panel 11, from the side of the first surface 19 in the direction of the arrow F. More specifically, the grasping end 44 is inserted into the bore 13a, until the flexible skirt 43 emerges from the opposite side. The body 16 of the insert is also inserted into the bore 13a, until the head 18 is placed in contact with the first surface 19 or, as in FIG. 3, with the countersinking of the bore 13a realized at the level of said surface 19.

Traction is then applied to the introduction rod 41, so as to press the flexible skirt 43 against the panel 11. The device 40, by means of said skirt 43, therefore exercises a traction force on the insert 15 along the axis 14, the head 18 of the insert and the retaining portion 42 resisting this force together. Once the retaining device 40 is released, the portion 42 dilates inside the tapping of the insert. Because of its elasticity, it crimps the insert 15 in the panel 11, preventing it from withdrawing from the bore 13a.

The insert being retained in the panel 11, the adhesive 27 is then solidified by polymerization in the open air or by curing depending on the nature of the material of the retaining device 40. The insert 15 becomes secured to the panel 11.

The retaining device 40 is then withdrawn from the insert 15 by pulling on the grasping end 44. The panel 11 with an insert 15 can then be assembled with a panel 12 by using a pin 22, to form the device 10 in FIG. 1.

1. Securing device for a structure having an open-ended cylindrical bore, the securing device comprising:
an insert comprising a cylindrical tubular body provided with internal tapping, a head with radial dimensions greater than the dimensions of the body, the extremity of the body opposite the head comprising an annular cavity holding a ring made of a plastic material;
a pin comprising a cylindrical tapped rod assembled with the tapping of the insert, a head with radial dimensions greater than the dimensions of said rod, the extremity of the cylindrical threaded rod being tapered;
the device being characterized in that the threaded rod is introduced into the insert on the ring side such that, in the assembled state, the head of the insert and the head of the pin form the terminal ends of the securing device.

2. Device according to claim 1, such that the outer surface of the tubular body of the insert comprises longitudinal splines.

3. Device according to claim 1, such that the tapered threaded portion of the pin is contained within the body of the insert in the assembled state.

4. Device according to claim 1 such that the head of the insert is countersunk and the head of the pin protrudes.

5. Device according to claim 1 such that the ring, in the new state, has an internal diameter less than the maximum diameter of the threaded rod of the pin.

6. Structure having an open-ended cylindrical bore, said structure comprising a securing device according to claim 1, such that the body of the insert is inserted into the bore, the outer surface of the tubular body being connected to an inner surface of the bore using an adhesive.

7. Structure according to claim 6 such that the head of the insert is in contact with a surface of the structure.

8. Assembly for the installation of a securing device in a structure having an open-ended cylindrical bore, said assembly comprising:
a securing device according to claim 1;
a device for retaining the insert, formed in a deformable material, said retaining device comprising:
an introduction rod, having a diameter smaller than an inner diameter of the insert;
a retaining portion adjacent to the introduction rod, having a diameter greater than the inner diameter of the insert and able to be introduced into the insert by compression;
a flexible skirt, adjacent to the retaining portion, a flare of the skirt being oriented towards said retaining portion;
a grasping end, adjacent to the flexible skirt.

9. Method for installing a securing device in a structure having an open-ended cylindrical bore utilizing an assembly according to claim 8 and comprising the following steps:
inserting the introduction rod of the device into the insert, from the side opposite the head;
immobilizing the insert around the retaining portion by compression of said portion;
distributing a curable viscous adhesive fluid over the outer surface of the body of the insert or in the bore;
inserting the retaining device into the bore of the structure from the side of a first surface, by the grasping end, until the flexible skirt emerges from an opposite side and the head of the insert is placed in contact with the first surface;
pulling on the introduction rod so as to press the flexible skirt against the structure;
curing the adhesive;
extracting the retaining device by pulling on the grasping end.

10. Method according to claim 9, such that the ring made of plastic material, in the new state, is tapped by screwing a threaded rod into the insert, said threaded rod then being introduced from the side of the head of the insert, before or after the insert is installed in the structure.
